(19) United States
(12) Patent Application Publication
(10) Pub. No.: US 2014/0168068 A1
(43) Pub. Date: Jun. 19, 2014

(54) SYSTEM AND METHOD FOR MANIPULATING USER INTERFACE USING WRIST ANGLE IN VEHICLE

(71) Applicant: Hyundai Motor Company, Seoul (KR)

(72) Inventor: Sung Un Kim, Yongin (KR)

(73) Assignee: HYUNDAI MOTOR COMPANY, Seoul (KR)

(21) Appl. No.: 14/103,027

(22) Filed: Dec. 11, 2013

(30) Foreign Application Priority Data
Dec. 18, 2012 (KR) 10-2012-0148813

(51) Int. Cl. G06F 3/01

(52) U.S. Cl. CPC G06F 3/017
USPC 345/156

(57) ABSTRACT

A method and system of manipulating a user interface using a wrist angle that include receiving, by a controller, an image captured by an image photographing unit and detecting shapes of arms and hands of the passenger from the captured image to calculate the wrist angle. In addition, the method includes recognizing, by the controller, wrist gesture information that corresponds to a change in the calculated wrist angle and selecting a vehicle device manipulation that corresponds to the recognized wrist gesture information.

### CROSS-REFERENCE TO RELATED APPLICATION

This application claims priority to and the benefit of Korean Patent Application No. 10-2012-0148813 filed in the Korean Intellectual Property Office on Dec. 18, 2012, the entire contents of which are incorporated herein by reference.

### BACKGROUND

(a) Field of the Invention

The present invention relates to a method of manipulating a user interface in which a gesture of a passenger is recognized using a wrist angle to operate devices within a vehicle.

(b) Description of the Related Art

Recently, various electronic devices are mounted within a vehicle for the convenience of a passenger. Specifically, electronic devices such as a radio and an air conditioner are mounted in a conventional vehicle and recently, electronic devices such as a navigation system and a mobile telephone hands free system are being mounted within a vehicle.

The electronic devices in the conventional vehicle provide a user interface through a designated button. A passenger must directly contact the electronic devices with a hand to manipulate the electronic devices. In addition, since such a manipulation is based on passenger's eyes and hand operation, safe driving may be disturbed. Therefore, it is necessary to develop an interface technology for the convenience of a user without disturbing driving. Therefore, in a conventional art, a distance is measured and a speed is detected using an ultrasonic wave sensor to recognize a position or motion of a hand.

In addition, a reflected signal is detected using an infrared beam to indirectly detect a presence or position of a hand. Further, an approach of a hand is electrically recognized using a capacitive sensor to recognize the hand from a short distance.

Recently, a technology of recognizing a gesture by transmitting and receiving radio waves such as an antenna using a conductivity of a body has been developed. In a method using an imaging device (e.g., a camera), a shape or movement of a hand is detected to recognize a gesture of the hand.

The above-described conventional method of recognizing a hand gesture includes a technology of observing a shape of a hand or detecting a hand and recognizing a motion of a hand. However, the conventional method has a drawback in that a recognition rate is low since a degree of freedom of a shape of the hand is high and brightness or a color of a hand is similar to periphery of the hand.

The above information disclosed in this section is only for enhancement of understanding of the background of the invention and therefore it may contain information that does not form the prior art that is already known in this country to a person of ordinary skill in the art.

### SUMMARY

The present invention provides a system and a method for extracting a wrist angle of a passenger from image information photographed by an imaging device (e.g., a camera) within a vehicle, recognizing a gesture using the wrist angle, and operating various electronic devices within the vehicle.

A method of manipulating a user interface using a wrist angle in a vehicle may include receiving an image from an imaging device, detecting shapes of arms and hands of a passenger from the image to calculate the wrist angle and recognizing wrist gesture information corresponding to a change in the calculated wrist angle, and selecting a vehicle device manipulation corresponding to the recognized wrist gesture information.

Recognizing the wrist gesture information in the image may include detecting shapes of arms and hands of a passenger from the image, calculating a wrist angle from positions of the detected arms and hands, repeating the above step for a predetermined time to generate a change in the calculated wrist angle, and recognizing wrist gesture information corresponding to the change in the calculated wrist angle.

Furthermore, recognizing the wrist gesture information corresponding to the change in the calculated wrist angle may include determining whether the wrist gesture information matched to the change in the calculated wrist angle is stored in an information database and, when it is determined that the wrist gesture information matched to the change in the calculated wrist angle is stored in the information database, recognizing the stored wrist gesture information as the wrist gesture information of the passenger.

The method may further include determining whether a wrist gesture recognizing function is requested before receiving the image from the imaging device. When it is determined that the wrist gesture recognizing function is requested to be used, the image may be received from the imaging device. In addition, the method may include determining whether it is requested to terminate the wrist gesture recognizing function and, when it is determined that it is requested to terminate the wrist gesture recognizing function, the wrist gesture recognizing function may be terminated.

A system for manipulating a user interface using a wrist angle in a vehicle may include an image photographing unit that captures an image, an image storage unit that stores the captured image, an information database that stores recognizable wrist gesture information and device manipulation information corresponding to the wrist gesture information, and an electronic control unit (ECU) that operates a vehicle device manipulation based on an input signal from the image photographing unit and accumulated image information stored in the image storage unit. The ECU may execute a series of commands for performing the method.

The system may further include an input unit that receives a signal for requesting a wrist gesture recognizing function from a passenger to transmit the signal to the ECU and an output unit that displays a vehicle device manipulation content of the ECU.

### BRIEF DESCRIPTION OF THE DRAWINGS

FIG. 1 is an exemplary view schematically illustrating a user interface system using a wrist angle in a vehicle according to an exemplary embodiment of the present invention;

FIG. 2 is an exemplary block diagram of the electronic control unit (ECU) of FIG. 1 according to an exemplary embodiment of the present invention;

FIG. 3 is an exemplary view illustrating an example of measurement of a wrist angle and a fingertip vector according to an exemplary embodiment of the present invention;

FIG. 4 is an exemplary view of an operation corresponding to a wrist gesture according to an exemplary embodiment of the present invention; and

FIG. 5 is an exemplary flowchart illustrating a method of manipulating a user interface using a wrist angle in a vehicle according to an exemplary embodiment of the present invention.

### DESCRIPTION OF SYMBOLS

100: input unit

110: image photographing unit

120: information database

130: electronic control unit

140: output unit

150: image storage unit

160: timer

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings. As those skilled in the art would realize, the described exemplary embodiments may be modified in various different ways, all without departing from the spirit or scope of the present invention. In addition, since elements in the drawings are arbitrarily represented for convenience sake, the present invention is not necessarily limited to the drawings.

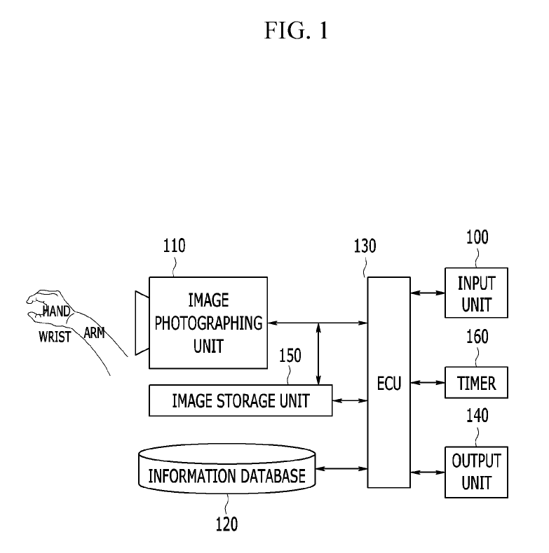

FIG. 1 is an exemplary view schematically illustrating a user interface system using a wrist angle in a vehicle according to an exemplary embodiment of the present invention. Referring to FIG. 1, a user interface (UI) system using a wrist angle according to an exemplary embodiment of the present invention may include a plurality of unites executed by an electronic control unit (ECU) 130. The plurality of units may include an input unit 100, an image photographing unit 110, an information database 120, a timer 160, an image storage unit 150, and an output unit 140.

The input unit 100 may include a button and a touch screen. In particular, an input signal is described to be generated by the button or the touch screen. However, a voice and a gesture are available for another input method. The image photographing unit 110 may include an imaging device (e.g., a camera), a photo sensor, an ultrasonic wave sensor, and an image sensor and may be configured to capture an image. In addition, the image photographing unit 110 may be positioned in the vicinity of, under, or on a steering wheel and in a position where an image of the body of a user such as the hands and legs of a user may be easily photographed.

Furthermore, the image storage unit 150 may be configured to accumulate frames of the image captured by the image photographing unit 110 to store the accumulated frames or may store the image processed by the ECU 130. The timer 160 may be configured to check time of each captured image. The information database 120 may be configured to store wrist gesture information that corresponds to predetermined various changes in a wrist angle. In addition, device manipulation information corresponding to the wrist gesture information may be stored when necessary.

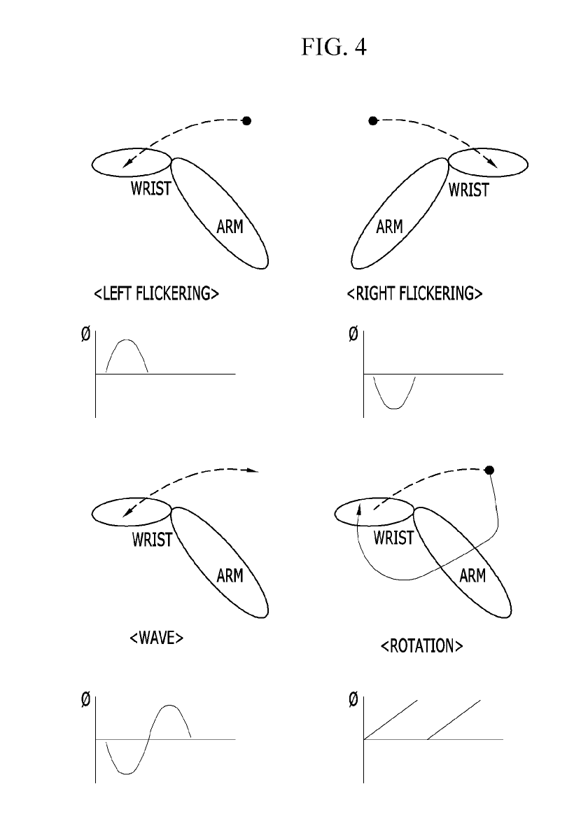

For example, as illustrated in FIG. 4, when a wrist performs operations such as left flicking, right flicking, a wave, and a rotation, selectable vehicle device manipulations may be left and right song selections, power on/off, and volume up/down. Other than the above, music stop, music on/off, music temporary stop, and air conditioner on/off may be performed for various wrist gestures.

The stored wrist gesture information may be predetermined for commonly defined gestures. In addition, the information database 120 may be configured to store wrist gesture information registered by a passenger. A passenger may select various wrist angle change information items to store the selected information items as wrist gestures. In other words, the passenger may directly input his or her wrist angle change information as a wrist gesture and thus, information regarding a change in a part of a body may vary for every passenger, for example, a wrist angle may be recognized as a wrist gesture without an error.

The ECU 130 may be configured to detect a hand and an arm from the image input from the image photographing unit 110 and calculate a wrist angle from the detected hand and arm. The calculated wrist angle may be repeatedly accumulated to calculate a change in the wrist angle. In addition, a current image frame and a previous image frame stored in the image storage unit 150 may be compared, by the ECU 130, to detect the change in the wrist angle. The wrist angle change generating method may have various modifications and the wrist angle change information may be detected by other methods.

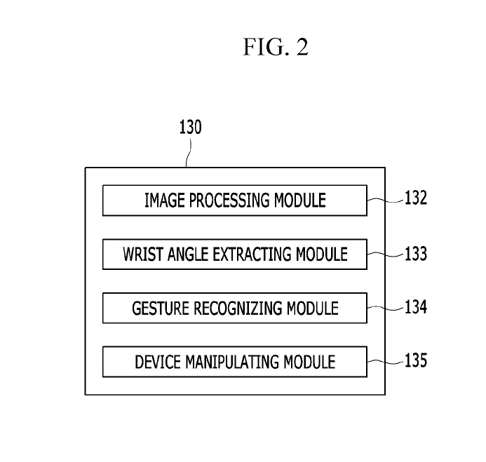

Referring to FIG. 2, the ECU 130 may include an image processing module 132, a wrist angle extracting module 133, a gesture recognizing module 134, and a device manipulating module 135 all operated by the ECU 130.

The image processing module 132 may be configured to process the image of the imaging device. In addition, the image processing module 132 may be configured to determine whether a wrist gesture recognizing function is to be used based on the input signal of the input unit 100. In other words, when the input signal that instructs the wrist gesture recognizing function to be used or terminated, the image processing module 132 of the ECU 130 may be configured to operate the image photographing unit 110 to start or terminate capturing of images. In addition, an area in which a hand of a user moves may be photographed.

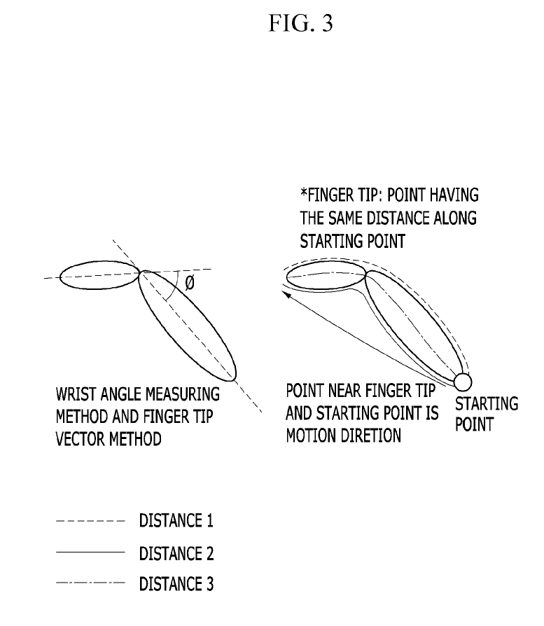

The wrist angle extracting module 133 may be configured to process an image based on a body image. In other words, a body peripheral image may be removed from a real image and a virtual image of the body image of the passenger and the extracted image may be divided into a head, a body, arms, hands, and legs to be modeled. Linear components may be obtained from narrow and wide shapes in the modeled hand and arm images. Such an example is illustrated in FIG. 3.

Referring to FIG. 3, an angle between the linear components of the hand and arm may be defined as the wrist angle. When the hand is distinguished from the arm, a distance may be measured from a starting point of the arm of FIG. 3 along an outline of the arm so that the remotest point may be regarded as a finger tip. A part in which curvature of the outline for the fingertip is substantially increased may be detected as a wrist point.

In another method of obtaining a wrist angle, for the fingertip, when an arm starting point vector is formed on the left of an arm image vector, a left motion may be determined and, when the arm starting point vector is formed on the right of the arm image vector, a right motion may be determined

The gesture recognizing module 134 may be configured to recognize a wrist gesture from a change in a wrist angle at predetermined time with reference to the information database 120. The predetermined time for recognizing the wrist gesture from a change in the wrist angle may be checked with reference to the timer 160. Then, the gesture recognizing module 134 may be configured to determine whether wrist gesture information matched to the obtained change in the wrist angle is stored in the information database 120. When the wrist gesture matched to the change in the wrist angle is stored, the gesture recognizing module 134 may be configured to recognize the wrist gesture as the wrist gesture of the passenger.

In addition, the device manipulating module 135 may be configured to select a vehicle device manipulation corresponding to the recognized wrist gesture. In other words, the device manipulating module 135 of the ECU 130 may be configured to generate a control signal based on the selected vehicle device manipulation to operate a desired manipulation. For example, the selectable vehicle device manipulations may be song selection, power on and off, sound increase and decrease, mobile phone answering and turning off, music reproduction/stop/mute, air conditioner on and off, heater on and off, and a sun visor manipulation.

The output unit 140 may include a touch screen, a speaker, a mobile telephone that is an object of the vehicle device manipulation, a music device, an air conditioner, a heater, a sun visor, and a content manipulation. In addition, a vehicle device manipulation content may be output to a screen.

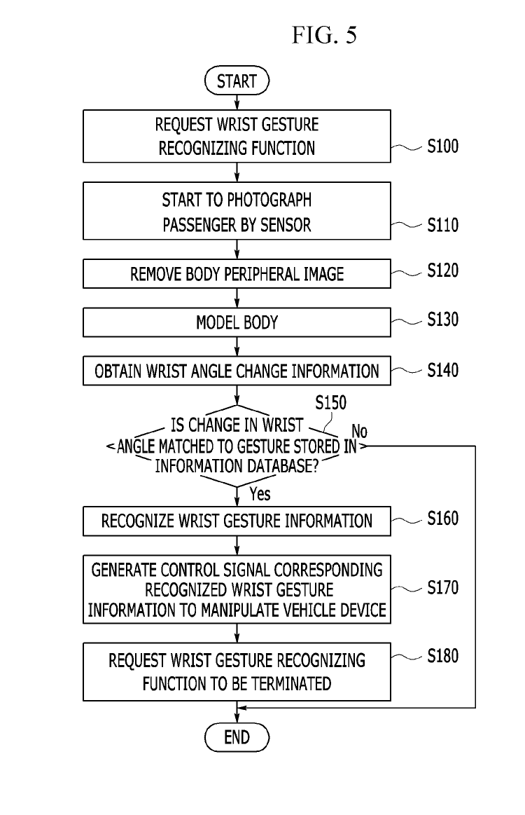

FIG. 5 is an exemplary flowchart illustrating a method of manipulating a user interface using a two-dimensional imaging device (e.g., a camera) in a vehicle according to an exemplary embodiment of the present invention. Referring to FIG. 5, a passenger may request a wrist gesture recognizing function by the input unit 100 S 100.

When the wrist gesture recognizing function is requested, the image processing module 132 of the ECU 130 may be configured to begin capturing images of the body or a hand of the passenger via the image photographing unit 110 S110. Then, the image captured by the image photographing unit 110 may be output to the ECU 130 to be processed by the image processing module 132 and may be accumulated to be stored in the image storage unit 150 S120.

The wrist angle extracting module 133 may be configured to remove a body peripheral image from the captured image S120. In addition, the wrist angle extracting module 133 may be configured to divide the extracted image into a body, arms, and hands to be modeled S130 and extract only hand and arm images to calculate a wrist angle. By such a method, the wrist angle may be calculated for a predetermined time and a change in the wrist angle may be extracted S 140. The method of extracting the change in the wrist angle may have various modifications.

Then, the gesture recognizing module 134 may be configured to determine whether a wrist gesture matched to the extracted change in the wrist angle is stored in the information database 120 S150. When it is determined by the gesture recognizing module 134 that the wrist gesture matched to the change in the wrist angle is stored in the information database 130, the matched wrist gesture may be recognized as the wrist gesture of the passenger S160.

Further, the device manipulating module 135 may be configured to select a vehicle device manipulation corresponding to the recognized wrist gesture. The device manipulating module 135 may be configured to generate a control signal based on the selected vehicle device manipulation to provide a desired manipulation desired S170. The vehicle device manipulation may include manipulations of an air conditioning system and an audio system within a vehicle and may be applied to transmission, copy, storage, and correction of information such as contents or media.

The manipulation result may be output via the output unit 140 and the user interface using recognition of the wrist gesture may be terminated based on whether a driver requests the wrist gesture recognizing function to be terminated S180.

According to the exemplary embodiment of the present invention, since a gesture may be expressed using a wrist, a passenger may conveniently express a gesture. In addition, according to the exemplary embodiment of the present invention, recognition of a shape of a hand may not be limited to allow a gesture to be freely recognized. In addition, according to the exemplary embodiment of the present invention, since a passenger may manipulate a steering wheel with a hand and may simply control various electronic devices within a vehicle with the other hand while keeping eyes forward, it may be possible to improve the convenience and driving safety of a passenger.

While this invention has been described in connection with what is presently considered to be exemplary embodiments, it is to be understood that the invention is not limited to the disclosed embodiments. On the contrary, it is intended to cover various modifications and equivalent arrangements included within the spirit and scope of the accompanying claims.

What is claimed is:

1. A method of manipulating a user interface using a wrist angle in a vehicle, comprising:
receiving, by a controller, an image captured by an image photographing unit;
detecting, by the controller, shapes of arms and hands of a passenger from the captured image to calculate the wrist angle;
recognizing, by the controller, wrist gesture information corresponding to a change in the calculated wrist angle; and
selecting, by the controller, a vehicle device manipulation corresponding to the recognized wrist gesture information.

2. The method of claim 1, wherein recognizing the wrist gesture information in the photographed image further includes:
detecting, by the controller, shapes of arms and hands of a passenger from the captured image;
calculating, by the controller, a wrist angle from positions of the detected arms and hands;
repeating, by the controller, the detecting and the calculating for a predetermined time to generate a change in the calculated wrist angle; and
recognizing, by the controller, wrist gesture information corresponding to the change in the calculated wrist angle.

3. The method of claim 2, wherein recognizing the wrist gesture information corresponding to the change in the calculated wrist angle further includes:
determining, by the controller, whether the wrist gesture information matched to the change in the calculated wrist angle is stored in an information database; and
in response to determining that the wrist gesture information matched to the change in the calculated wrist angle is stored in the information database, recognizing, by the controller, the stored wrist gesture information as the wrist gesture information of the passenger.

4. The method of claim 1, further comprising:
determining, by the controller, whether a wrist gesture recognizing function is requested before receiving the captured image; and
in response to determining that the wrist gesture recognizing function is requested to be used, receiving, by the controller, the captured image.

5. The method of claim 1, further comprising:
determining, by the controller, a request to terminate the wrist gesture recognizing function; and
in response to receiving the request to terminate the wrist gesture recognizing function, terminating, by the controller, the wrist gesture recognizing function.

6. A system that manipulates a user interface using a wrist angle in a vehicle, comprising:
an image photographing unit configured to capture an image;
an image storage unit configured to store an image captured by the image photographing unit;
an information database configured to store recognizable wrist gesture information and device manipulation information corresponding to the wrist gesture information; and
a controller configured to operate a vehicle device manipulation based on an input signal from the image photographing unit and accumulated image information stored in the image storage unit.

7. The system of claim 6, wherein the controller is further configured to:
receive a signal requesting a wrist gesture recognizing function; and
display a vehicle device manipulation content.

8. A non-transitory computer readable medium containing program instructions executed by a processor or controller, the computer readable medium comprising:
program instructions that receive an image captured by an image photographing unit;
program instructions that detect shapes of arms and hands of a passenger from the captured image to calculate the wrist angle;
program instructions that recognize wrist gesture information corresponding to a change in the calculated wrist angle; and
program instructions that select a vehicle device manipulation corresponding to the recognized wrist gesture information.

9. The non-transitory computer readable medium of claim 8, further comprising:
program instructions that detect shapes of arms and hands of a passenger from the captured image;
program instructions that calculate a wrist angle from positions of the detected arms and hands;
program instructions that repeat the detection and the calculation for a predetermined time to generate a change in the calculated wrist angle; and
program instructions that recognize wrist gesture information corresponding to the change in the calculated wrist angle.

10. The non-transitory computer readable medium of claim 9, further comprising:
program instructions that determine whether the wrist gesture information matched to the change in the calculated wrist angle is stored in an information database; and
program instructions that recognize the stored wrist gesture information as the wrist gesture information of the passenger, in response to determining that the wrist gesture information matched to the change in the calculated wrist angle is stored in the information database.

11. The non-transitory computer readable medium of claim 8, further comprising:
program instructions that determine whether a wrist gesture recognizing function is requested before receiving the captured image; and
program instructions that receive the captured image in response to determining that the wrist gesture recognizing function is requested to be used.
